(19) United States
(12) Patent Application Publication
(10) Pub. No.: US 2023/0302414 A1
(43) Pub. Date: Sep. 28, 2023

(54) DEVICES FOR PURIFYING A LIQUID, AND RELATED SYSTEMS AND METHODS

(71) Applicant: ENTEGRIS, INC., Billerica, MA (US)

(72) Inventors: Aabid Ali MIR, Bedford, MA (US); Jad Ali JABER, Westford, MA (US); Vinay GOEL, Acton, MA (US); John A. LEYS, Chaska, MN (US); Yasushi OHYASHIKI, Narashino-shi (JP)

(21) Appl. No.: 18/126,291

(22) Filed: Mar. 24, 2023

Related U.S. Application Data
(60) Provisional application No. 63/323,518, filed on Mar. 25, 2022.

(51) Int. Cl. B01D 69/14; B01D 61/14; B01D 71/06

(52) U.S. Cl. CPC B01D 69/147; B01D 61/145; B01D 71/06; B01D 2311/22; B01D 2311/2626; B01D 2313/23; B01D 2325/02832; B01D 2325/02833; B01D 2325/02834; B01D 2325/12

(57) ABSTRACT

Described are devices for purifying a liquid that is contained in a sealable container, to storage systems for containing and purifying a liquid, and to related methods.

### FIELD

The following description relates to devices for purifying a liquid that is contained in a sealable container, to storage systems for containing and purifying a liquid, and to related methods.

### BACKGROUND

Various types of manufacturing processes across different industries use liquids of high purity for manufacturing or processing techniques, including for pharmaceuticals, biotechnology, medicine, and semiconductor and microelectronic device manufacturing. Liquids that are considered to have a purity may contain an amount of impurities (total) that is on a scale of parts per million, parts per billion, or even parts per trillion, including liquids referred to as “ultrapure liquids.”

Examples of liquids that may be used in pure or ultrapure form include liquid acids, solvents, bases, photoresist solutions, dopants, biological solutions (which may be inorganic or organic), pharmaceutical materials, and radioactive chemicals, among others.

When handling, storing, or transporting these liquids, the equipment and flow controls that are used are designed to avoid introducing impurities into the liquids. Particularly, for relatively pure liquids that are used in microelectronic and semiconductor manufacturing processes, manufacturers have established strict particle concentration specifications for process chemicals and chemical-handling equipment. Such controls are useful because impurities in these liquids become deposited on surfaces of a semiconductor or microelectronic device during use of the liquids. An impurity in the liquid becomes a contaminant on the device surface and can lead to product failure and reduced quality and reliability.

Containers used for storing and transporting liquids require systems that are capable of providing a high level of protection of the liquids from exposure to impurities.

### SUMMARY

The following describes purifier devices and methods that use a purifier device to remove impurities from a volume of liquid contained in a sealed container. Also described are systems for containing and transporting a liquid in a sealed container in the presence of a purifier device that removes impurities from the liquid while the liquid is transported in the sealed container.

A purifier device or system can be useful to remove an impurity from any type of liquid, and is useful, for example, to purify a liquid that is used for microelectronic or semiconductor processing. Impurities present in these types of liquids include micron-scale or nano-scale dissolved or suspended molecules contained in the liquid in a concentration that may be in a range of parts per million (ppm) or less, e.g., 100 ppm, 50 ppm, 10 ppm, or less. Example impurities include dissolved hydrocarbons, dissolved metal ions, and dissolved metals. The liquid that is purified by a method or system as described is already relatively pure, and has been processed by one or more previous purification or filtering steps, but does still contain a remaining amount of impurities.

The purifier includes a liquid-permeable porous membrane that contains an interior that contains solid adsorbent. The porous membrane allows the liquid and dissolved impurity to pass through the porous membrane and into the purifier to contact the adsorbent, which adsorbs and sequesters the impurity from the liquid and removes the impurity from the liquid. The adsorbent may be effective to remove a significant portion of an original amount of impurity contained in a liquid. At the same time, the pores of the purifier are small enough to prevent even the smallest particle fragments of adsorbent to be released from the purifier into the liquid.

The adsorbent may be any type of solid adsorbent, such as carbon (activated carbon), ZIF, MOF, polymeric, or another type of adsorbent. The liquid may be any relatively pure liquid, and particularly includes liquids useful in semiconductor processing, such as purified organic solvents, just a single example being isopropyl alcohol. The impurity may be a dissolved impurity that is present at a very low level, e.g., at a concentration in a parts-per-million range or lower, with examples being dissolved non-volatile hydrocarbons, metal atoms, and metal ions.

In one aspect, the disclosure relates to a purifier. The purifier includes: a porous membrane having pores of sub-micron average pore size, a sealed interior, and adsorbent at the interior.

In another aspect, the disclosure relates to a storage system for containing a liquid. The system includes: a sealable container having an interior, and a purifier. The purifier includes: a porous membrane having a pores of sub-micron average pore size, a sealed interior, and adsorbent at the interior.

In yet another aspect, the disclosure relates to a method of removing impurity from a liquid. The method includes placing a purifier into a container. The purifier includes: a porous membrane having pores of sub-micron average pore size, a sealed interior, and adsorbent at the interior. The container also includes a liquid that contains impurity. The method includes allowing the liquid to pass through the membrane and contact the adsorbent, and the impurity to be adsorbed by the adsorbent.

### BRIEF DESCRIPTION OF THE DRAWINGS

FIGS. 1A (top view) and 1B (side, cut-away view) show an example of a purifier.

FIG. 2 is an example storage system that includes a sealable container and a purifier.

FIG. 3 shows data relating to example purifiers for purifying isopropyl alcohol (IPA).

FIG. 4 shows data relating to example purifiers for purifying ammonium hydroxide.

All figures are not to scale.

### DETAILED DESCRIPTION

The following describes purifier devices (referred to as a “purifiers,” “static purifiers,” or the like) and methods that use a purifier device to remove impurities from a volume of liquid contained in a sealed container. Also described are systems for containing and transporting a liquid in a sealed container in the presence of a purifier device that removes impurities from the liquid while transporting the liquid.

A purifier as described is a device that includes a purifier body that forms a sealed and enclosed interior, and a porous membrane that forms at least a portion of the purifier body, with solid adsorbent contained within the interior.

The purifier can be submersed in a liquid that contains impurities. The porous membrane is permeable to liquid (which contains impurities) in which the purifier is submersed, and allows the liquid and impurities to flow between an exterior of the purifier and the purifier interior to contact the adsorbent. The membrane also prevents solid adsorbent from the interior, even small particles of the solid adsorbent, to pass from the sealed interior into the liquid in which the purifier is submersed. The adsorbent is capable of adsorbing impurities that are contained in the liquid to sequester the impurities and remove the impurities from the liquid, but does not substantially adsorb the liquid itself.

The purifier can be used by placing the purifier into a fixed volume of a liquid that contains an amount of impurities, and allowing the liquid to contact the purifier so that the liquid and impurities pass through the membrane and contact the adsorbent, and so an amount of the impurities in the liquid are adsorbed by the solid adsorbent. The liquid can be a fixed volume of liquid that is contained in a sealable container.

The impurities are said to be “removed” from the volume of liquid by the impurities being adsorbed onto the adsorbent contained in the purifier interior and taken out of the bulk liquid in which the purifier device is submersed. In this context, “removing” impurities from a volume of liquid refers an interaction between a purifier and a fixed volume of liquid that reduces a total amount of one or more impurities that are originally present in the bulk volume of liquid (the “bulk volume” of liquid, or “bulk liquid” is the volume of liquid within the container other than the volume of the purifier). “Removing” impurities does not require a purifier to remove an entire amount of one or more impurities originally present in the volume of liquid. As used herein, “removing” impurities from a volume of liquid includes a process that reduces a total amount impurities (of a single type, or of a mixture of two or more impurities) in the volume of liquid from an original amount of impurities to a lower (reduced) amount of impurities, with at least a portion of the original amount of impurities becoming adsorbed by the adsorbent.

The purifier device may be referred to as a “static purifier” because the purifier device can be placed in a fixed (i.e., static) volume of liquid, in a container that does not require a flow if liquid into and out of the container (through the container); the static purifier is submersed in the fixed volume of liquid to allow the liquid and impurities in the liquid to pass through the purifier membrane where the impurities contact the adsorbent and are adsorbed on and sequestered by the adsorbent and removed from the volume of liquid in the container.

The purifier device includes a purifier body (or “exterior body” or “body”) that is sealed to define a purifier interior. The body includes a porous liquid-permeable membrane over at least a portion of the exterior to allow liquid to pass between the purifier interior and the purifier exterior. The membrane is arranged relative to the interior to allow liquid to pass through the membrane to enter the purifier interior, and may define the entire body or only a portion of the body. A purifier body may be in the form of a sealed sachet, pouch, envelope, or bag, etc., or any other form of a sealed container that includes a porous liquid permeable membrane between the purifier device exterior and the purifier device interior. For convenience herein, all different forms of exterior bodies of sealed purifier devices that include a membrane and that define the purifier interior may be referred generically as a “pouch” or “purifier pouch.”

The porous membrane contains pores that allow liquid and impurities that are dissolved in the liquid to pass between the purifier interior and the purifier exterior when the purifier is submersed in the liquid. Useful purifier bodies are sealed (other than the pores of the porous membrane) to prevent any solid particles (which may be derived from adsorbent particles contained at the purifier interior) to pass from the purifier interior that contains the adsorbent, into the liquid in which the purifier is submersed. Even very small particles that may be contained in the purifier interior are not capable of passing from the interior of the purifier into liquid at the exterior. As used herein, the term “sealed” refers to a purifier body that allows liquid or any other material to pass between the purifier interior and the purifier exterior only through pores in a porous liquid-permeable membrane, but does not have any other openings that allow material, particularly solid particles of adsorbent, to pass between the interior and the exterior.

Example adsorbent materials are made of solid particles having particles sized on a macro scale, e.g., on a scale of millimeters or larger. Adsorbent particles of any size, though, can generate smaller particles by mechanical contact between the particles, or by otherwise sloughing or shedding minute fragments of solid adsorbent material from the larger particles. In a collection of adsorbent particles contained in a purifier interior, having macro dimensions, the adsorbent may produce particles of much smaller sizes, such as below 200 microns, 100 microns, 50 microns, 10 microns, or 1 micron. These particles are not allowed pass from the sealed purifier interior to the purifier exterior and into to a volume of bulk liquid in which the purifier is submersed. If these particles were to pass to the bulk liquid and the liquid is a process liquid used in semiconductor processing, the particles become contaminants in the liquid that cause processing difficulties, defects in a microprocessing device processed using the liquid, reduced yield, or the like.

Accordingly, a purifier device of the present description does not contain any openings other than pores through the porous membrane, and does not allow particles of these sizes to pass from the purifier interior to the purifier exterior. Example purifier bodies do not contain any openings that are capable of allowing passage of a particle having a size greater than 10 microns, e.g., greater than 5 microns, or greater than 1 micron. Example purifier pouches do not contain any openings that are larger than 10 microns, e.g., that are larger than 5 microns, e.g., that are larger than 1 micron.

Example pouches can be formed from one or multiple pieces (e.g., sheets) of porous liquid-permeable membrane (“membrane” for short) by assembling the one or multiple pieces of membrane into a pouch structure that defines a sealed purifier interior. The pouch may include sealed ends or edges that are in the form of a fold in the membrane, that are sides or edges of a rolled tube, or that are prepared by bonding two different pieces or layers of one or more membranes at their edges to form a bonded, sealed edge or end of the pouch.

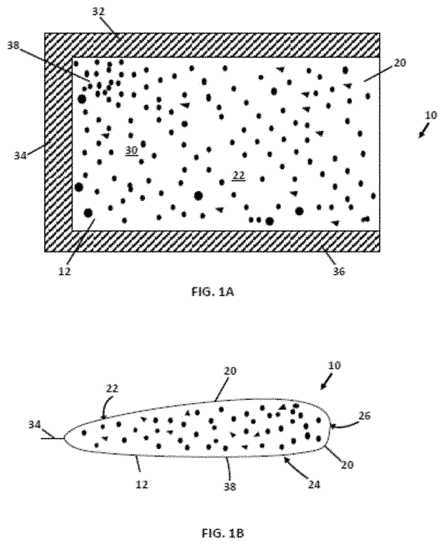

At FIGS. 1A (top view) and 1B (side view) are illustrations of an example purifier device 10 of the present description. Purifier 10 includes pouch (pouch body) 12 made of membrane 20 having two sides, 22 and 24, formed and connected at fold 26 at one end of device 10. Purifier interior 30 is formed between top side 22, bottom side 24, folded edge 26, and three bonded edges 32, 34, and 36. Adsorbent 38 is held within sealed interior 30. Bonded edges may be formed from edges of top side 22 and bottom side 24 by any manner of bonding the respective edges together to form sealed edges 32, 34, and 36, such as by heat welding, sonic welding, a polymeric (thermoplastic) bonding agent, or the like.

As illustrated, the entire body and exterior of pouch 12 is made of flexible membrane 20. Alternately, as desired, portions of a pouch body of a purifier device may contain other materials, e.g., non-porous materials that are relatively more rigid than a flexible polymeric membrane, to add structure. Also as illustrated, sealed interior 30 contains only adsorbent 38 and no other material. As illustrated, purifier 10 consists of or consists essentially of the membrane and the adsorbent contained at the interior of the membrane. A purifier that consists essentially of the membrane and adsorbent does not contain more than an insubstantial amount of any other material, e.g., contains the membrane and the adsorbent and not more than 5, 3, 1, or 0.5 weight percent of any other material or materials.

A porous membrane (or sometimes “membrane” for short) that may be useful as a pouch or as a component of a pouch is a flexible polymeric membrane that is porous and liquid permeable to allow liquid to pass through the membrane and to allow impurities present in the liquid (e.g., dissolved impurities) to pass through the membrane, but that does not allow any solid material derived from adsorbent contained within he pouch to pass through the membrane, e.g., particles made of the adsorbent and having a particle size of 1 micron, e.g., 5 microns, or 10 microns. A membrane should be inert to a liquid chemical in which the purifier will be submersed, should be wettable by a liquid chemical in which the purifier will be submersed, and should be porous with pore sizes that allow liquid to pass through the membrane but are sufficiently small to prevent any particles of adsorbent present at the purifier interior from passing through the membrane from the interior into a liquid in which the purifier is submersed.

Useful porous membranes include membranes referred to as “open pore” membranes, as compared to “closed pore” membranes. An open pore membrane can be in the form of a thin film or sheet of extruded porous polymeric material having a relatively uniform thickness and an open-pore porous structure that includes a polymeric matrix that defines a large number of open “cells,” which are three-dimensional void structures or pores, and that allow liquid to flow from one side of the membrane, through the membrane, to the other side of the membrane. The open cells can be referred to as openings, pores, channels, or passageways that are largely interconnected between adjacent cells to allow fluid (liquid) to flow through the thickness of the membrane from one side of the membrane to the other side of the membrane.

Porous membranes can be constructed as porous polymeric films having a length, width, and a significantly smaller thickness. The membranes have an open pore structure with pores having an average pore size for use as a porous membrane of a purifier as described herein, as well as for a particular type of liquid or impurity that will pass through the membrane during use of the purifier. For a purifier that will be used with a highly pure liquid that is used for processing a semiconductor material or microprocessing device, a membrane may have an average pore size in a sub-micron range, meaning an average pore size that is less than 1 micron. I.e., porous membranes that are useful as described include porous polymeric membranes of types that will be referred to herein as “sub-micron” filtration membranes.

Example sub-micron membranes include, generally, membranes that have an average pore size of below 1 micron. Within this category of membranes are: microporous membranes, which have an average pore size in a range from about 0.05 microns to 1 micron, and ultra ultraporous membranes (or “ultrafiltration membranes”), which have an average pore size in a range from 0.001 microns to about 0.05 microns. Pore size of a membrane can be measured by known techniques such as by Mercury Porosimetry (MP), Scanning Electron Microscopy (SEM), Liquid Displacement (LLDP), Atomic Force Microscopy (AFM), Gas Flow Porosimetry (Bubble Point), and Liquid-Liquid Porosimetry.

A porous membrane may be characterized by features that include the chemical (polymeric) makeup of the membrane, morphology of the membrane including distribution and of pores, porosity, and bubble point, among others.

Bubble point is a very common method used to measure pore size. To measure bubble point, a sample of porous polymeric membrane is immersed in and wetted with a liquid having a known surface tension, and a gas pressure is applied to one side of the sample. The gas pressure is gradually increased. The minimum pressure at which the gas flows through the sample is termed the initial bubble point.

To measure bubble point and pore size of a porous membrane as described, the following test was used. A sample of porous membrane is immersed in and wetted with ethoxy-nonafluorobutane HFE 7200 (available from 3M) at a temperature of 20-25° C. (e.g., 22° C.). A gas pressure is applied to one side of the sample by using compressed air and the gas pressure is gradually increased. The minimum pressure at which the gas flows through the sample and forms a bubble is called the initial bubble point. All bubble point values provided herein are measured using this procedure. Examples of useful bubble points of a porous polymeric filter membrane that is useful or preferred according to the present description, measured using the procedure described above, can be in a range from 1 to 50 psi (roughly a range for “microporous” membranes), e.g., from 50 to 150 psi (roughly a range for “ultrafiltration” membranes). The pore size of a useful membrane may be selected to be effective for the purpose of preventing particles of adsorbent of the smallest size that are contained within the sealed interior of the purifier from passing through the membrane and into a liquid in which the purifier is contained.

A porous membrane useful according to the present description may be made from any of various polymers, including polymers that are specifically known to be useful for preparing a range of useful porous membranes. A choice of a polymeric membrane may be based on factors such as the type of the liquid that the porous membrane in which the porous membrane will be submersed during use, so that the membrane is compatible: e.g., not degradable in the liquid and does not swell in the liquid.

Examples of useful polymers include polyimides, polyamide-polyimides, a polysulfones such as polyethersulfone or polyphenylsulfone, fluoropolymers such as polyvinylidene fluoride, polyolefins such as polyethylene and polypropylene, fluorinated polymers such as perfluoroalkoxy (PFA), and polyamides (e.g., nylon 6, nylon 66).

Suitable polyolefins include, for example, polyethylene (e.g., ultra high molecular weight polyethylene (UPE)), polypropylene, alpha-polyolefins, poly-3-methyl-1-butene, poly-4-methyl-1-butene, and copolymers of ethylene, propylene, 3-methyl-1-butene, or 4-methyl-1-butene with each other or with minor amounts of other olefins; example polyhaloolefins include polytetrafluoroethylene, polyvinylidene fluoride, and co-polymer of these and other fluorinated or non-fluorinated monomers. Example polyesters include polyethylene terephthalate and polybutylene terephthalate, as well as related co-polymers.

A porous membrane may be fluorinated (partially fluorinated), perfluorinated, or may contain entirely non-fluorinated polymer made essentially from non-fluorinated monomers, e.g., may comprise, consist of, or consist essentially of non-fluorinated polymer materials. Example porous membranes may comprise, consist of, or consist essentially of polyolefin, such as polyethylene (e.g. UPE). A porous membrane that consists essentially of non-fluorinated materials can contain less than 0.5, 0.1, or 0.01 weight percent fluorine. A porous membrane that consists essentially of polyolefin, e.g., polyethylene, can be derived from monomers that include at least 99, 99.5, or 99.0 weight percent polyolefin (e.g., polyethylene) monomers.

A porous membrane as described may have a porosity that allows the porous membrane to be effective as described herein, to allow liquid and impurity to pass from an exterior of the pouch to an interior of the pouch. Example porous membranes can have porosity at least 30 percent, or at least 50 percent, e.g., a porosity in a range from 20 to 85 percent. As used herein, and in the art of porous membranes, a “porosity” of a porous membrane (also sometimes referred to as void fraction) is a measure of the void (i.e. “empty”) space in the membrane as a percent of the total volume of the membrane, and is calculated as a fraction of the volume of voids of the membrane over the total volume of the membrane based on the outer dimensions of the membrane. A membrane that has zero percent porosity is completely solid.

A porous membrane useful as a portion of a pouch of a purifier as described can be in the form of a sheet (thin film) having any useful thickness, e.g., a thickness in a range from 12 to 1000 microns, e.g., from 5 or 10 to 100 or 200 microns.

A variety of different types of adsorbent materials are known and may be useful as an adsorbent in a purifier as described herein. General types of adsorbents include carbon-based adsorption, polymeric adsorbents such as those referred to as “porous organic polymers” (POP), polymer framework particles (PF), zeolitic adsorbents (“zeolites”), silicalite adsorbents, and metal-organic-framework adsorbents (MOF). Other examples include ceramics (e.g., silica), polymers, cellulosic adsorbents, functionalized adsorbents that contain ionic groups for contaminant-specific adsorption, e.g., adsorbent functionalized with ion-exchange ligands or affinity ligands. For a description, see United States patent publications 2021/0394169, 2020/0206691, 2021/0260537, and 2020/0254398; these describe ion exchange ligands and affinity ligands such as polycarboxylate ligands (e.g., iminodiacetic acid), polyol ligands such as n-methylglucamine, and polyphosphonic acid ligands. Examples of these are available commercially, e.g., as adsorbents useful in chromatography techniques.

Adsorbent particles can have properties such as particle size, pore size, and pore volume, which may be selected for adsorbent of a purifier based on factors such as the type of adsorbent, the type of liquid, the type of impurity, etc.

In general, the particle size of adsorbent useful in a purifier as described may be any particle size that is effective, for example particles having sizes in a range from 1 to 700 microns, although larger or smaller adsorbent particles may also be useful. Particle size of adsorbent particles can be measured by known techniques, including sieving techniques.

Useful metal-organic-framework (MOF) adsorbent materials exhibit various physical and molecular forms. Metal-organic frameworks are organic-inorganic hybrid crystalline porous materials that have molecular structures that include a regular repeating array of positively charged metal ions surrounded by organic “linker” molecules. The metal ions form nodes that bind the arms of the organic linker molecules together to form a repeating, hollow cage-like structure. With this hollow structure, MOFs have a large internal surface area that can be adapted for use to adsorb (and selectively desorb) impurities present in a liquid when used in a purifier device as described. Certain examples of MOF materials are described in U.S. Pat. No. 9,138,720, and also in United States Patent Application Publication 2016/0130199, the entireties of each of these documents being incorporated herein by reference.

A subclass of MOFs that are known as zeolitic adsorbents include zeolitic imidazolate frameworks (“ZIFs”), which consist of metal (mainly tetrahedral Zn2) bridged by the nitrogen atoms of imidazolate linkers. Zeolitic imidazolate frameworks are a type of MOF that includes a tetrahedrally-coordinated transition metal such as iron (Fe), cobalt (Co), Copper (Cu), or Zinc (Zn), connected by imidazolate linkers, which may be the same or different within a particular ZIF composition or relative to a single transition metal atom of a ZIF structure. The ZIF structure includes four-coordinated transition metals linked through imidazolate units to produce extended frameworks based on tetrahedral topologies. ZIFs are said to form structural topologies that are equivalent to those found in zeolites and other inorganic microporous oxide materials.

A zeolitic imidazolate framework can be characterized by features that include the type of transition metal (e.g., iron, cobalt, copper, or zinc), the chemistry of the linker (e.g., chemical substituents of the imidazolate units), pore size of the ZIF, surface area of the ZIF, pore volume of the ZIF, among other physical and chemical properties. Dozens (at least 105) of unique ZIF species or structures are known, each having a different chemical structure based on the type of transition metal and the type of linker (or linkers) that make up the framework. Each topology is identified using a unique ZIF designation, e.g., ZIF-1 through ZIF-105. For a description of ZIFs, including particular chemical compositions and related properties of a large number of known ZIF species, see Phan et al., “Synthesis, Structure, and Carbon Dioxide Capture Properties of Zeolitic Imidazolate Frameworks,” Accounts of Chemical Research, 2010, 43 (1), pp 58-67 (Received Apr. 6, 2009).

The term “carbon adsorbent” refers to a range of carbon-based materials that are derived synthetically from carbon-containing polymeric materials or from carbon-based materials having a natural source. Examples include: carbon formed by pyrolysis of synthetic hydrocarbon resins such as polyacrylonitrile, sulfonated polystryrene-divinylbenzene, polyvinylidene chloride, etc.; cellulosic char; charcoal; and activated carbon formed from natural source materials such as coconut shells, pitch, wood, petroleum, coal; nanoporous carbon, etc. Carbon adsorbents that can be particularly useful in a purifier and methods of using a purifier include carbon adsorbents that have a high purity.

Carbon adsorbent (as well as other types of adsorbents) may have any suitable form, such as a form of granules (also referred to as “particles”). Granules are individual pieces of carbon adsorbent, each piece having a relatively small size, such as less than 2 centimeters, or less than 1 or 0.5 centimeter. The particles may have any useful particle size, shape, and range of particle sizes. Examples shapes include beads, granules, pellets, tablets, shells, saddles, powders, irregularly-shaped particulates, extrudates of any shape and size, cloth or web form materials, honeycomb matrix monolith, and composites (of the adsorbent with other components), as well as comminuted or crushed forms of the foregoing types of adsorbent materials.

Useful or preferred carbon adsorbent particles (or other types of adsorbent particles) may have an average size that is in a range from 0.5 to 20 millimeters, such as from 1 to 15 or from 1 to 10 millimeters (mm). Average particle size for a collection of adsorbent particles can be measured by standard techniques, including random selection of particles from a collection of particles and measuring size (e.g., diameter) by use of a micrometer.

Pore sizes of adsorbent materials are classified in general ranges based on average pore sizes of a collection of adsorbent particles. Adsorbents that have an average pore size of greater than 50 nanometers (nm) are typically referred to as macroporous. Adsorbents that have an average pore size in a range from 2 to 50 nanometers (nm) are typically referred to as mesoporous particles. Adsorbents that have an average pore size of less than 2 nanometers are typically referred to as microporous. These terms are defined by IUPAC terminology. An adsorbent for use in a purifier may have pores in a macroporous range, pores in a mesoporous range, and pores in a microporous range.

A purifier of the present description can be useful for processing a liquid of various types across a range of liquid types that have commercial importance and are used in a relatively pure form. These include liquids that are useful in different types of industries (e.g., pharmaceutical manufacturing, semiconductor processing) and particularly include liquids that are used as process solvents, cleaning agents, and other processing liquids for semiconductor and microelectronic device processing, and require a very high level of purity during use. Examples broadly include liquid acids, solvents, bases, photoresist solutions, dopants, biological solutions (which may be inorganic or organic), pharmaceutical materials, and radioactive chemicals, among others. Specific examples of liquids used in semiconductor and microelectronic device manufacturing include solvents used in photolithography, cleaning, or various processes of manufacturing semiconductor and microelectronic devices. Specific examples include process solutions for spin-on-glass (SOG) techniques, for backside anti-reflective coating (BARC) methods, for photolithography, for cleaning methods, and the like.

The liquid is a liquid that, even before being contacted with a purifier of the present description, has been processed to remove impurity materials (including dissolved impurities or particulate impurities) from the liquid, (e.g., may be referred to as a “purified” liquid.) The liquid can be at least 99.99 percent pure, containing a total amount of one or more impurities that is below 0.01 percent (100 parts per million) or less, e.g., less than 100 parts per billion (before contacting the purifier). The impurities can be dissolved or suspended molecular impurities as opposed to impurities in particle (solid) form, e.g., an impurity may be a chemical compound or molecule having a size that is less than 100 nanometers.

The terms “parts-per-million” and “parts-per billion” are used in a manner that is consistent with the use of these terms in the chemical arts, including in the arts of manufacturing microelectronic and semiconductor devices. In this respect, parts per million (PPM) is commonly used as a dimensionless measure of small levels (concentrations) of a contaminant in fluid (a gas or liquid), expressed as milligrams contaminant per liter fluid (mg/L), and measures the mass of the contaminant per volume of the fluid. One part per million is equal to 0.000001 units. The liquid has already been processed and purified to remove impurities, and remaining impurities are present in only these “trace” amounts.

An impurity, also referred to as a “contaminant,” is a chemical material that is different from a liquid that contains the impurity and that is dissolved or suspended in the liquid in a non-solid (non-particulate) form and present at a very low amount, e.g., in a concentration in a parts-per-million (e.g., up to 100 parts per million) or parts-per-billion range, or lower.

An impurity in a liquid may be derived from any of various sources. An impurity may be present in a liquid as a by-product, un-used reactant, catalyst, or other chemical that was used to produce the liquid. Additionally, an impurity may be introduced to a liquid by exposure of the liquid to an atmospheric compound (e.g., water, carbon dioxide) or may be presented to a liquid by liquid handling or storage equipment such as a polymeric or metal flow control device (pipe, filter, catalyst, conduit), vessel body, valve, etc. Impurities may also be generated by interactions between the liquid and a different impurity in the system, e.g., water.

Example impurities, described in general chemical terms, include hydrocarbon molecules such as charged (ionic) molecules and oligomers, and inorganic compounds such as metal oxides (titanium dioxide), other organic molecules such as amines, metal atoms, metal ions, etc.

Example impurities in a molecular (non-solid) form can have a size of less than 100 nanometers, or less than 90, 50, 25, 10, 5, or 1 nanometer. Impurities of these sizes, if present in a liquid used for processing a semiconductor or microelectronic device, can produce a defect on the device and reduce a process yield.

An impurity can be present initially in a liquid in an amount of less than 100, 10, or 1 part-per-million, or less than 100, 10, or 1 part-per-billion.

According to various examples, certain types impurities are commonly present in certain types of liquids used in commercial processes. For example, polar organic solvents such as isopropyl alcohol may contain trace amounts of a hydrocarbon, a metal oxide such as a metal oxide, or a metal ion. Example methods as described can include removing one or more of these impurities from a polar organic solvent such as isopropyl alcohol.

Non-polar organic solvents such as an alkanes (e.g., hexane) may typically include impurities such as a hydrocarbon analog (e.g., a different non-polar alkane such as methane, propane, butane, or a C5 through C10 alkane), an hydrocarbon oligomer derivative of the alkane impurity or the non-polar organic solvent, or a metal. Example methods as described can include removing one or more of these impurities from a non-polar organic solvent such as hexane.

Some specific, non-limiting examples of liquid organic solvents that can be purified using a purifier as described, to remove a trace impurity, include: alkanes (methane, butane, hexane, and other C3 through C10 alkanes), n-butyl acetate (nBA), isopropyl alcohol (IPA), 2-ethoxyethyl acetate (2EEA), a xylene, cyclohexanone, ethyl lactate, methyl isobutyl carbinol (MIBC), methyl isobutyl ketone (MIBK), isoamyl acetate, undecane, propylene glycol methyl ether (PGME), and propylene glycol monomethyl ether acetate (PGMEA).

According to methods of using the described purifier, the purifier is placed within a container that contains a fixed amount (volume) of liquid. The container is sealable, meaning that the container can be sealed to enclose the liquid and the purifier submersed in the liquid in an air-tight, liquid-tight sealed interior of the container. The liquid, which contains an amount of one or more impurities, circulates within the volume of the container and passes (along with the impurity in the liquid) through the permeable membrane of the purifier to contact the adsorbent. When the liquid contacts the adsorbent, impurities in the liquid are adsorbed by the adsorbent, while the liquid itself is not adsorbed by the adsorbent.

The amount of adsorbent that is included in a purifier and in a specific volume of liquid held in a container can be any relative amount of adsorbent that will be effective to remove impurities from the liquid. The relative amount of adsorbent that is needed or used in a particular volume of liquid can depend on factors such as the type of adsorbent, the type of impurity, and the amount of impurity, as well as others. In example systems, a liquid that is contained in a container can contain from 0.2 to 10 grams of adsorbent per 50 milliliters of liquid in a container, e.g., from 0.5 to 5 grams adsorbent per 50 milliliter of liquid in the container.

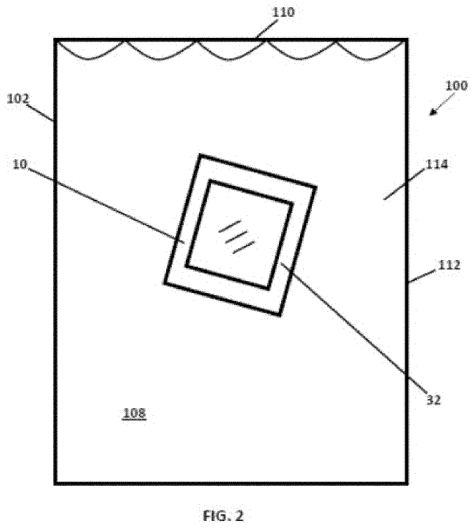

Referring to FIG. 2, illustrated is sealable container 102, which includes vessel 112, cover 110, and contains liquid 114 within interior 108. Sealable container 102 can be sealed using cover 110, which covers interior 108 to produce an air-tight, liquid-tight sealed interior 108 of container 102. Within interior 108 is liquid 114, which contains an amount of one or more impurities. After container 102 is sealed, liquid (along with the impurity in the liquid) within interior 108 will move, i.e., circulate, within the volume of interior 108, by any force that causes movement of the liquid within interior 108. For example, liquid 114 will be caused to move within interior 108 by normal handling of sealed container 102 during transport from a first location to a second location, by truck, train, airplane, or boat. The movement of sealed container 102 during transport from the first location to the second location causes the liquid to circulate within the volume of the container interior 108, and to pass through the permeable membrane of purifier 10 to contact the adsorbent at the interior of purifier 10. When liquid 114 contacts adsorbent at the interior of purifier 10, impurities in liquid 114 are adsorbed by the adsorbent. The liquid is not adsorbed by the adsorbent but passes back through the permeable membrane of purifier 10 and returns to the bulk liquid within interior 108 of sealed container 102.

During transport of the sealed container, movement of the sealed container (e.g., by truck, train, plane, or ship) causes incidental movement of the liquid within the closed container, relative to the container. For example, the container may be transported to a different location and during transport is agitated by normal handling techniques of the container and the liquid contents, which cause the liquid to circulate within the container due to movement of the container. The liquid moves within the container without the need for powered mechanical propulsion of the liquid relative to the container. A system or method of the disclosure does not require and may specifically exclude the use of a mechanical propulsion device such as a pump, mixer, stirrer, impeller, or the like, that contacts the liquid or otherwise and operates on the liquid to move the liquid relative to the container.

In these example systems, a previously-purified liquid undergoes an additional purification step during transport or handling of the liquid in a sealed container, by contact of the liquid with the purifier device in the container. The liquid and the purifier are both added to the container before the container is sealed. When the sealed container is stored or transported, the liquid is further purified by the purifier, as described. When the liquid is eventually removed from the container the liquid contains a lower concentration of at least one impurity compared to the amount of the at least one impurity that was contained in the liquid when the liquid was initially placed in the container. In example systems, a concentration of one or more impurities present in a liquid when the liquid is added to a sealable container may be reduced by at least 70, or 80 percent, i.e., the purifier will remove at least 70, 80, 90, 99, 99.5, or 99.9 percent of one or more impurities originally present in a liquid.

The amount of time that the liquid remains in the container in the presence of the purifier can be an amount of time that is effective to allow the adsorbent to remove a high percentage of at least one impurity from the liquid. For example, the liquid and purifier may remain in the container, with the container being sealed for at least 24 hours, 1 day, 2 days, 7 days, or at least 14 days. During this period the sealed container may be stored or transported, such as by truck, airplane, train, or ship.

The container may be any type of sealed container that is useful to store or transport the liquid within a sealed (air-tight, liquid-tight) interior of the container.

For comparison, the container may be of a type that is not designed to be used to contain a liquid during a chemical processing step that involves the liquid, e.g., as would a chemical container used for a reaction process (a reaction vessel), a filtering apparatus, or a different chemical process that is performed in an open or a closed vessel (container) and that involves the liquid flowing into the container at an inlet, through a volume of the container, then out of the container through an outlet. Example sealable containers of system and method of the present description do not operate with a flow of liquid flowing through the container, e.g., with the liquid flowing continuously from an inlet into the container, through a volume of the container, and the from the volume of the container to exit the container, while the container continuously contains a volume of the liquid within the volume of the container.

Examples of closed and “sealable” containers include those that are sometimes referred to as barrels, totes, tanks, cylinders, drums, canisters, etc., including types that are specifically known for use to store or transport liquids for commercial use.

A useful container may have an interior for holding a volume of liquid that is of any useful size, such as from 1 liter to 55 gallons, or more. The container includes an opening or an inlet through which liquid is added to the interior of the container, and that can be closed, i.e., tightly sealed (to prevent passage of air or liquid), to allow the container to be stored or transported. In this respect, the container is “sealable,” meaning adapted and designed to be closed and sealed by a lid, a plug, a cap, or another mechanical device or structure that is adapted to tightly fit an opening of the container to isolate and seal (in an air-tight and liquid-tight fashion) the interior from an exterior of the container, with the seal preventing liquid or air from entering the container interior even during movement and handling of the sealed container during transport by train, airplane, truck, or ship.

Example containers include those used for transporting and delivering commercial liquids of very high purity. Containers of this type include those sold by Entegris® (Billerica MA), under the trade names NOWPak® and PDMPak®. Example volumes of interiors of these containers may be up to or in excess of 1, 2.5, 4, 10, 18, 19, 20, 40, 200, 500, 800, and 1200 liters.

Such containers may be characterized by features that allow a liquid to be placed into the container at a very high purity and then held, transported, and dispensed from the container while being protected from exposure to chemical and environmental impurities and contamination. An example feature is an interior surface of a container, or a flexible and re-movable liner at the interior of the container, that contacts the liquid and separates the liquid from the exterior sidewall structure of the container. Examples of coatings and flexible liners may be made of a chemically inert polymeric material such as a fluoropolymer (e.g., polytetrafluoroethylene (PTFE), polyfluoroalkyl (PFA)) or polyethylene (e.g., high density polyethylene(HDPE)). Other examples of this type of container may be lined with a glass liner, as opposed to a polymeric material.

Example sidewall structures of a container may include a container structure made of metal (e.g., stainless steel) that is lined with a chemically-inert polymer, or that contains a removable liner. Examples of these container systems can include specialized dispense systems that do not allow liquid contents of the container to be exposed to environmental contaminants when the liquid is dispensed from the container. The dispensing system may include, for example, a dispenser that produces a sealed (e.g., air-tight) engagement with the container at an opening in the container, such as with a threaded engagement between the container and the dispenser. This type of a dispense system may be directly connected to a semiconductor processing tool, as with the ErgoNOW™ “on-tool” dispense system sold by Entegris.

The container, when sealed, does not require an elevated pressure within the sealed container and may have a pressure at the interior that is approximately atmospheric, e.g., approximately 760 Torr (absolute), e.g., below 1200 Torr or below 900 Torr (absolute).

Preferred containers are of a type designed to handle, store, contain, transport, and dispense highly pure liquid materials such as semiconductor processing liquids in a manner that maintains the high level of purity of the contained liquid and is designed to avoid or prevent the introduction of added impurities to the contained liquid. Examples of containers for storing, shipping, and containing highly pure liquids are known and are commercially available.

Versions of these types of containers are made of polymeric materials or of metal, such as stainless steel. Versions of these containers include an interior surface that may be permanent, or that may be a surface of a removable liner, that is made of polymeric material that is designed to contain the liquid while introducing not more than a very low amount of added impurity to a contained liquid. Commercial examples of useful containers include those marketed by Entegris, Inc., of Billerica MA, under the trade names NOWpak® and Fluor® Pure®.

Examples of containers that include a removable liner at the interior are described in U.S. Pat. No. 9,631,774, the entirety of which is incorporated herein by reference. A removable liner is used at an interior of a container, and is present within the container while the container contains and optionally transports a first volume (a first “batch”) of liquid. The container can be stored, held, or transported, etc., and the liquid can be removed from the container interior. After the first volume of liquid is removed from the container interior, the liner can be removed from the container interior. A second liner can then be placed within the container interior, and a second volume (second batch) of liquid can be added to the container with the second liner, then stored, held, transported, or dispensed, etc.

An interior surface of a container as described, or a removable liner of a container, may be made of one or more polymers, including plastics, nylons, EVOH, polyolefins, or other natural or synthetic polymers. Alternate polymers include polyethylene terephthalate (PET), polyethylene naphthalate (PEN), poly(butylene 2,6-naphthalate) (PBN), polyethylene (PE), linear low-density polyethylene (LLDPE), low-density polyethylene (LDPE), medium-density polyethylene (MDPE), high-density polyethylene (HDPE), and/or polypropylene (PP). In still alternative embodiments, a liner may be manufactured using a fluoropolymer, such as but not limited to, polychlorotrifluoroethylene (PCTFE), polytetrafluoroethylene (PTFE), fluorinated ethylene propylene (FEP), and perfluoroalkoxy (PFA). Further, a liner may contain multiple layers. For example, in certain embodiments, a liner may include an internal surface layer, a core layer, and an outer layer, or any other suitable number of layers. The multiple layers may include one or more different polymers or other suitable materials. For example, an internal surface layer may be manufactured using a fluoropolymer (e.g., PCTFE, PTFE, FEP, PFA, etc.) and a core layer may be a gas barrier layer manufactured using such materials as nylon, EVOH, polyethylene naphthalate (PEN), PCTFE, etc. The outer layer may also be manufactured using any variety of suitable materials and may depend on the materials selected for the internal surface layer and core layer. The liner may be a collapsible liner that may be flexible, or may be substantially rigid.

During use of the liquid, the liquid can be removed from the container by any suitable equipment and technique, such as by use of a pump or a differential pressure.

### Example 1

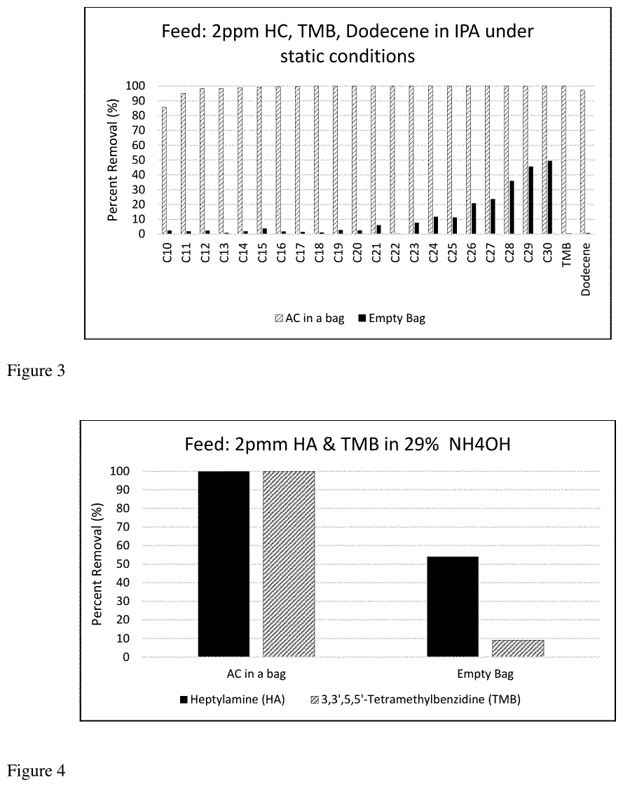

To show efficacy of a purifier to remove very low levels of various types of impurity from a isopropyl alcohol or “IPA,” the following purifier samples were prepared and tested in IPA.
0.2 um UPE membranes were used to prepare purifier devices (pouches or “bags”). The bags were sealed using Impulse Sealer (AIE-300) and filled with activated carbon (AC).
The UPE bags containing AC were immersed in IPA containing spiked model contaminants.
A UPE bag of similar area without any activated carbon at the interior was also prepared and used as a control.
Soak tests were performed under static conditions for 24 hrs, without the use of an impeller or pump to mix the liquid, but using constant shaking. Each bag was placed in a sample of IPA having an initial amount of impurity at a level of 2 parts per million (ppm).
Model impurities were: Long chain Hydrocarbons (C10-C30), Dodecene, and 3,3′,5,5′-tetramethylbenzidine (TMB).
   Results are shown at FIG. 3. As shown, at least 80 or 90 percent of the model impurities were removed from the IPA liquid in the bag with the activated carbon verses less than 50% of the hydrocarbons and less than 5% of the TMB and Dodecene for the empty bag.

### Example 2

To show efficacy of a purifier to remove very low levels of various types of impurity from a 29% solution of ammonium hydroxide, the following purifier samples were prepared and tested in the ammonium hydroxide.
0.2 um UPE membranes were used to prepare purifier devices (pouches or “bags”). The bags were sealed using Impulse Sealer (AIE-300) and filled with activated carbon (AC).
The UPE bags containing AC were immersed in the ammonium hydroxide containing spiked model contaminants.
A UPE bag of similar area without any activated carbon at the interior was also prepared and used as a control.
Soak tests were performed under static conditions for 24 hrs, without the use of an impeller or pump to mix the liquid, but using constant shaking. Each bag was placed in a sample of the ammonium hydroxide having an initial amount of impurity at a level of 2 parts per million (ppm).
Model impurities were: heptylamine (HA) and 3,3′,5,5′-tetramethylbenzidine (TMB).
   Results are shown at FIG. 4. As shown, over 95% of the model impurities were removed from the ammonium hydroxide using the bag with the activated carbon verses less than 60% of the HA and less than 10% of the TMB for the empty bag.

In a first aspect, a purifier comprises a porous membrane having pores of sub-micron average pore size, a sealed interior, and adsorbent at the interior.

A second aspect according to the first aspect, wherein the membrane is a microporous membrane having pores of average pore size in a range from 0.05 to 1 micron.

A third aspect according to the first aspect, wherein the membrane is an ultraporous membrane having pores of average pore size in a range from 0.001 microns to 0.05 microns.

A fourth aspect according to any of the first through third aspects, wherein the membrane comprises polymer selected from: a polyamide, a polyimide, a polyamide-polyimide, a polysulfones, a fluoropolymer, a polyolefin, and a polyamine.

A fifth aspect according to any of the first through fourth aspects, wherein the adsorbent is selected from: carbon-based adsorbent, porous organic polymer, polymer framework particles, zeolitic adsorption particles, silicalite particles, and metal-organic-framework particles.

In a sixth aspect, a storage system for containing a liquid comprises: a sealable container comprising an interior, and a purifier comprising: a porous membrane having pores of sub-micron average pore size, a sealed interior, and adsorbent at the interior.

A seventh aspect according to the sixth aspect, wherein the membrane is a microporous membrane having pores of an average pore size in a range from 0.05 to 1 micron.

An eighth aspect according to the seventh aspect, wherein the membrane is an ultrafiltration membrane having pores of an average pore size in a range from 0.001 microns to 0.05 microns.

A ninth aspect according to any of the sixth through eighth aspects, wherein the membrane comprises polymer selected from: a polyamide, a polyimide, a polyamide-polyimide, a polysulfone, a fluoropolymer, a polyolefin, and a nylon.

A tenth aspect according to any of the sixth through nineth aspects, wherein the adsorbent is selected from: carbon-based adsorbent, porous organic polymer, polymer framework particles, zeolitic adsorption particles, silicalite particles, and metal-organic-framework particles.

An eleventh aspect according to any of the sixth through tenth aspects, there is from 0.5 g to 5 grams adsorbent per 50 milliliter of solvent in the container.

A twelfth aspect according to any of the sixth through eleventh aspects, wherein the container includes a removable liner.

A thirteenth aspect according to any of the sixth through twelfth aspects, wherein the container has an interior volume in a range from 1 to 200 liters.

A fourteenth aspect according to any of the sixth through thirteenth aspects, wherein the container contains liquid that is at least 99.99 percent pure, and contains impurity having a size below 100 nanometers, at a concentration below 100 parts per million.

A fifteenth aspect according to the fourteenth aspect, wherein the liquid is useful as a semiconductor processing fluid.

A sixteenth aspect according to the fourteenth or fifteenth aspect, wherein the liquid is a polar organic solvent or a non-polar organic solvent.

A seventeenth aspect according to any of the fourteenth through sixteenth aspects, wherein the liquid is isopropyl alcohol or ammonium.

An eighteenth aspect according to any of the fourteenth through sixteenth aspects, wherein the liquid is selected from: an alkane (methane, butane, hexane, and other C3 through C10 alkanes), n-butyl acetate (nBA), isopropyl alcohol (IPA), 2-ethoxyethyl acetate (2EEA), an amine (e.g., ammonium), a xylene, cyclohexanone, ethyl lactate, methyl isobutyl carbinol (MIBC), methyl isobutyl ketone (MIBK), isoamyl acetate, undecane, propylene glycol methyl ether (PGME), and propylene glycol monomethyl ether acetate (PGMEA).

A nineteenth aspect according to any of the fourteenth through eighteenth aspects wherein the impurity is an alkane.

A twentieth aspect according to the fourteenth aspect, wherein the liquid is a polar organic solvent and the impurity is a hydrocarbon, a metal oxide, or a metal ion.

In a twenty-first aspect, a method of removing impurity from a liquid comprises placing a purifier in a container having a container volume, the purifier comprising: a porous membrane having pores of sub-micron average pore size, a sealed interior, and adsorbent at the interior, and liquid that contains impurity, and allowing the liquid to pass through the membrane and contact the adsorbent, and the impurity to be adsorbed by the adsorbent.

A twenty-second aspect according to a twenty-first aspect, wherein the container includes a removable liner.

A twenty-third aspect according to twenty-first or twenty-second aspect, wherein the liquid circulates within the container by motion of the container and without a mechanical circulation device.

A twenty-fourth aspect according to any of the twenty-first through twenty-third aspects, further comprising: sealing the container, transporting the sealed container, and opening the sealed container after not less than 24 hours.

A twenty-fifth aspect according to any of the twenty-first through twenty-fourth aspects, wherein the liquid is at least 99.99 percent pure, and contains impurity having a size below 100 nanometers, at a concentration below 100 parts per million.

A twenty-sixth aspect according to any of the twenty-first through twenty-fifth aspects, wherein the liquid is useful as a semiconductor processing fluid.

A twenty-seventh aspect according to any of the twenty-first through twenty-sixth aspects, wherein the liquid is a polar organic solvent or a non-polar organic solvent.

A twenty-eighth aspect according to any of the twenty-first through twenty-seventh aspects, wherein the liquid is isopropyl alcohol or ammonium.

A twenty-ninth aspect according to any of the twenty-first through twenty-eighth aspects, wherein the liquid is selected from: an alkane (methane, butane, hexane, and other C3 through C10 alkanes), n-butyl acetate (nBA), isopropyl alcohol (IPA), 2-ethoxyethyl acetate (2EEA), an amine (e.g., ammonium), a xylene, cyclohexanone, ethyl lactate, methyl isobutyl carbinol (MIBC), methyl isobutyl ketone (MIBK), isoamyl acetate, undecane, propylene glycol methyl ether (PGME), and propylene glycol monomethyl ether acetate (PGMEA).

A thirtieth aspect according to any of the twenty-first through twenty-ninth aspects, wherein the impurity is an alkane.

A thirty-first aspect according to any of the twenty-first through thirtieth aspects, wherein the fluid is a polar organic solvent and the impurity is a hydrocarbon, a metal oxide, or a metal ion.

A thirty-second aspect according to any of the twenty-first through thirty-first aspects, wherein: when placed in the container, the liquid contains an initial amount of impurity at a concentration below 100 parts per million, and the adsorbent removes at least 80 percent of the initial amount of the impurity.

1. A purifier comprising:
a porous membrane having pores of sub-micron average pore size,
a sealed interior, and
adsorbent at the interior.

2. The purifier of claim 1, wherein the membrane is a microporous membrane having pores of average pore size in a range from 0.05 to 1 micron.

3. The purifier of claim 1, wherein the membrane is an ultraporous membrane having pores of average pore size in a range from 0.001 microns to 0.05 microns.

4. The purifier of claim 1, wherein the membrane comprises polymer selected from: a polyamide, a polyimide, a polyamide-polyimide, a polysulfones, a fluoropolymer, a polyolefin, and a polyamine.

5. The purifier of claim 1, wherein the adsorbent is selected from: carbon-based adsorbent, porous organic polymer, polymer framework particles, zeolitic adsorption particles, silicalite particles, and metal-organic-framework particles.

6. A storage system for containing a liquid, the system comprising:
a sealable container comprising an interior, and
a purifier comprising:
a porous membrane having pores of sub-micron average pore size,
a sealed interior, and
adsorbent at the interior.

7. The storage system of claim 6, wherein the membrane is a microporous membrane having pores of an average pore size in a range from 0.05 to 1 micron.

8. The storage system of claim 6, wherein the membrane is an ultrafiltration membrane having pores of an average pore size in a range from 0.001 microns to 0.05 microns.

9. The storage system of claim 6, wherein the membrane comprises polymer selected from: a polyamide, a polyimide, a polyamide-polyimide, a polysulfone, a fluoropolymer, a polyolefin, and a nylon.

10. The storage system of claim 6, wherein the adsorbent is selected from: carbon-based adsorbent, porous organic polymer, polymer framework particles, zeolitic adsorption particles, silicalite particles, and metal-organic-framework particles.

11. The storage system of claim 6, wherein there is from 0.5 g to 5 grams adsorbent per 50 milliliter of solvent in the container.

12. The storage system of claim 6, wherein the container includes a removable liner.

13. The storage system of claim 6, wherein the container has an interior volume in a range from 1 to 200 liters.

14. The storage system of claim 6, wherein the container contains liquid that is at least 99.99 percent pure, and contains impurity having a size below 100 nanometers, at a concentration below 100 parts per million.

15. The storage system of claim 14, wherein the liquid is useful as a semiconductor processing fluid.

16. The storage system of claim 14, wherein the liquid is a polar organic solvent or a non-polar organic solvent.

17. The storage system of claim 14, wherein the liquid is isopropyl alcohol or ammonium.

18. The storage system of claim 14, wherein the liquid is selected from: an alkane (methane, butane, hexane, and other C3 through C10 alkanes), n-butyl acetate (nBA), isopropyl alcohol (IPA), 2-ethoxyethyl acetate (2EEA), an amine (e.g., ammonium), a xylene, cyclohexanone, ethyl lactate, methyl isobutyl carbinol (MIBC), methyl isobutyl ketone (MIBK), isoamyl acetate, undecane, propylene glycol methyl ether (PGME), and propylene glycol monomethyl ether acetate (PGMEA).

19. The storage system of claim 14, wherein the impurity is an alkane.

20. The storage system of claim 14, wherein the liquid is a polar organic solvent and the impurity is a hydrocarbon, a metal oxide, or a metal ion.

21. A method of removing impurity from a liquid, the method comprising:
placing a purifier in a container having a container volume, the purifier comprising:
a porous membrane having pores of sub-micron average pore size,
a sealed interior, and
adsorbent at the interior, and
liquid that contains impurity, and
allowing the liquid to pass through the membrane and contact the adsorbent, and the impurity to be adsorbed by the adsorbent.

22. The method of claim 21, wherein the container includes a removable liner.

23. The method of claim 21, wherein the liquid circulates within the container by motion of the container and without a mechanical circulation device.

24. The method of claim 21, further comprising: sealing the
container,
transporting the sealed container, and
opening the sealed container after not less than 24 hours.

25. The method of claim 21, wherein the liquid is at least 99.99 percent pure, and contains impurity having a size below 100 nanometers, at a concentration below 100 parts per million.

26. The method of claim 21, wherein the liquid is useful as a semiconductor processing fluid.

27. The method of claim 21, wherein the liquid is a polar organic solvent or a non-polar organic solvent.

28. The method of claim 21, wherein the liquid is isopropyl alcohol or ammonium.

29. The method of claim 21, wherein the liquid is selected from: an alkane (methane, butane, hexane, and other C3 through C10 alkanes), n-butyl acetate (nBA), isopropyl alcohol (IPA), 2-ethoxyethyl acetate (2EEA), an amine (e.g., ammonium), a xylene, cyclohexanone, ethyl lactate, methyl isobutyl carbinol (MIBC), methyl isobutyl ketone (MIBK), isoamyl acetate, undecane, propylene glycol methyl ether (PGME), and propylene glycol monomethyl ether acetate (PGMEA).

30. The method of claim 21, wherein the impurity is an alkane.

31. The method of claim 21, wherein the fluid is a polar organic solvent and the impurity is a hydrocarbon, a metal oxide, or a metal ion.

32. The method of claim 21, wherein:
when placed in the container, the liquid contains an initial amount of impurity at a concentration below 100 parts per million, and
the adsorbent removes at least 80 percent of the initial amount of the impurity.
